(19) United States
(12) Patent Application Publication
(10) Pub. No.: US 2015/0354336 A1
(43) Pub. Date: Dec. 10, 2015

(54) CONTROL PARAMETER DETERMINATION IN STEAM ASSISTED GRAVITY DRAINAGE OIL DRILLING

(71) Applicant: SAS Institute Inc., Cary, NC (US)

(72) Inventors: Sebastian Maurice, Calgary (CA); Gerhard Roets, Cochrane (CA)

(21) Appl. No.: 14/487,488

(22) Filed: Sep. 16, 2014

Related U.S. Application Data
(60) Provisional application No. 62/008,482, filed on Jun. 5, 2014.

(51) Int. Cl. E21B 44/06; G06N 3/063; G06N 99/00; G05D 15/01

(52) U.S. Cl. CPC E21B 44/06; G05D 15/01; G06N 3/063; G06N 99/005

(57) ABSTRACT

Drilling data including a plurality of values measured for each of a plurality of drilling parameters is received. An objective function that maximizes production of a material produced by a production operation, minimizes water usage by the production operation, and minimizes a sub-cool temperature of the material is determined using the received drilling data. An association rule that defines a range of values for a control parameter of the plurality of drilling parameters that is selected based on a value of a first parameter of the plurality of drilling parameters is determined using the received drilling data. Measured drilling data that indicates current control parameter values of the production operation is received. An optimal value for the control parameter is determined by executing the determined objective function with the received, measured drilling data as an input and subject to the determined association rule. The determined optimal value is output.

### CROSS-REFERENCE TO RELATED APPLICATIONS

The present application claims the benefit of 35 U.S.C. §119(e) to U.S. Provisional Patent Application No. 62/008,482 filed on Jun. 5, 2014, the entire contents of which is hereby incorporated by reference.

### BACKGROUND

Steam assisted gravity drainage (SAGD) may be effective in reservoirs containing highly viscous oil, or bitumen. Referring to FIG. 1, in the SAGD process, two parallel horizontal wells, one above the other, are utilized where a steam injection well 100 injects steam into a top line 102. A producer well 108 is an oil producer. When steam is continually injected into top line 102, a steam chamber is developed that grows upward to the surroundings and heats the surrounding oil in rock and shale. Hot oil and condensed water drain, through the force of gravity, to bottom line 104 that is below top line 102. The mixture of bitumen and water is pumped to producer well 108 at the surface using a pump 106. At the surface, the water is separated from the bitumen and returned to steam injection well 100 for re-injection into top line 102.

### SUMMARY

In an example embodiment, a method of determining an optimal value for a control parameter of a production operation is provided. Drilling data including a plurality of values measured for each of a plurality of drilling parameters is received. An objective function is determined using the received drilling data. The objective function maximizes production of a material produced by a production operation, minimizes water usage by the production operation, and minimizes a difference between a boiling point of water and a temperature of the material produced by the production operation at a same pressure. An association rule is determined using the received drilling data. The association rule defines a range of values for a control parameter of the plurality of drilling parameters that is selected based on a value of a first parameter of the plurality of drilling parameters. Measured drilling data is received that indicates current control parameter values of the production operation. An optimal value for the control parameter of the production operation is determined by executing the determined objective function with the received, measured drilling data as an input and subject to the determined association rule. The determined optimal value is output.

In another example embodiment, a computer-readable medium is provided having stored thereon computer-readable instructions that, when executed by a computing device, cause the computing device to perform the method of determining an optimal value for a control parameter of a production operation.

In yet another example embodiment, a computing device is provided. The system includes, but is not limited to, a processor and a computer-readable medium operably coupled to the processor. The computer-readable medium has instructions stored thereon that, when executed by the computing device, cause the computing device to perform the method of determining an optimal value for a control parameter of a production operation.

Other principal features of the disclosed subject matter will become apparent to those skilled in the art upon review of the following drawings, the detailed description, and the appended claims.

### BRIEF DESCRIPTION OF THE DRAWINGS

Illustrative embodiments of the disclosed subject matter will hereafter be described referring to the accompanying drawings, wherein like numerals denote like elements.

FIG. 1 depicts a block diagram of a steam assisted gravity drainage production operation in accordance with an illustrative embodiment.

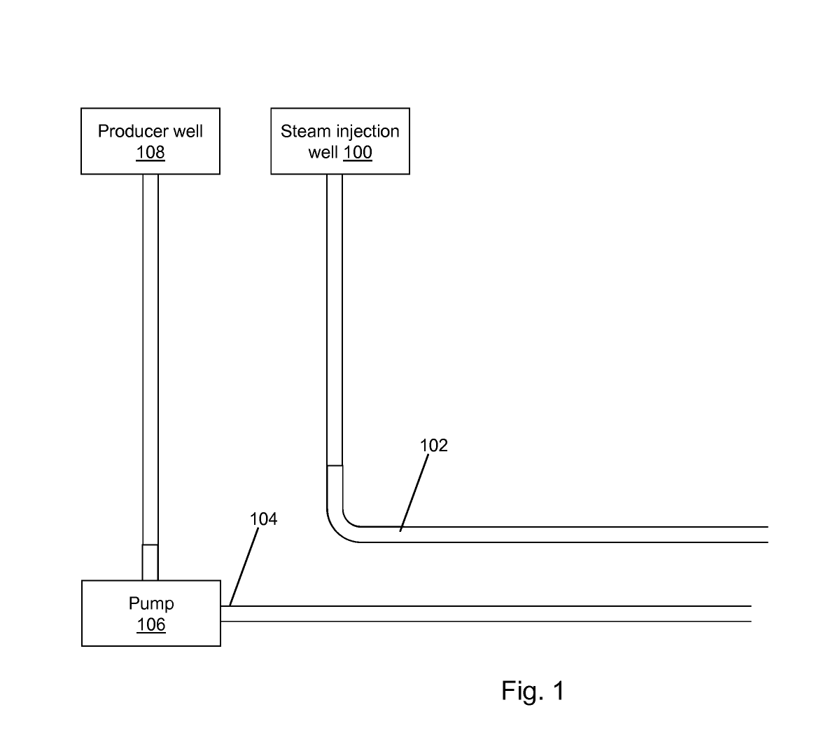

FIG. 2 depicts a block diagram of a data optimization device in accordance with an illustrative embodiment.

FIG. 3 depicts a flow diagram illustrating examples of operations performed by the data optimization device of FIG. 2 in accordance with an illustrative embodiment.

FIG. 4 depicts a further block diagram of the data optimization device of FIG. 2 in accordance with an illustrative embodiment.

FIG. 5 depicts a flow diagram illustrating further examples of operations performed by the data optimization device of FIG. 4 in accordance with an illustrative embodiment.

FIG. 6 depicts a block diagram of a distributed processing system in accordance with an illustrative embodiment.

FIG. 7 depicts a block diagram of a distributed control device of the distributed processing system of FIG. 6 in accordance with an illustrative embodiment.

FIG. 8 depicts a block diagram of a data node device of the distributed processing system of FIG. 6 in accordance with an illustrative embodiment.

### DETAILED DESCRIPTION

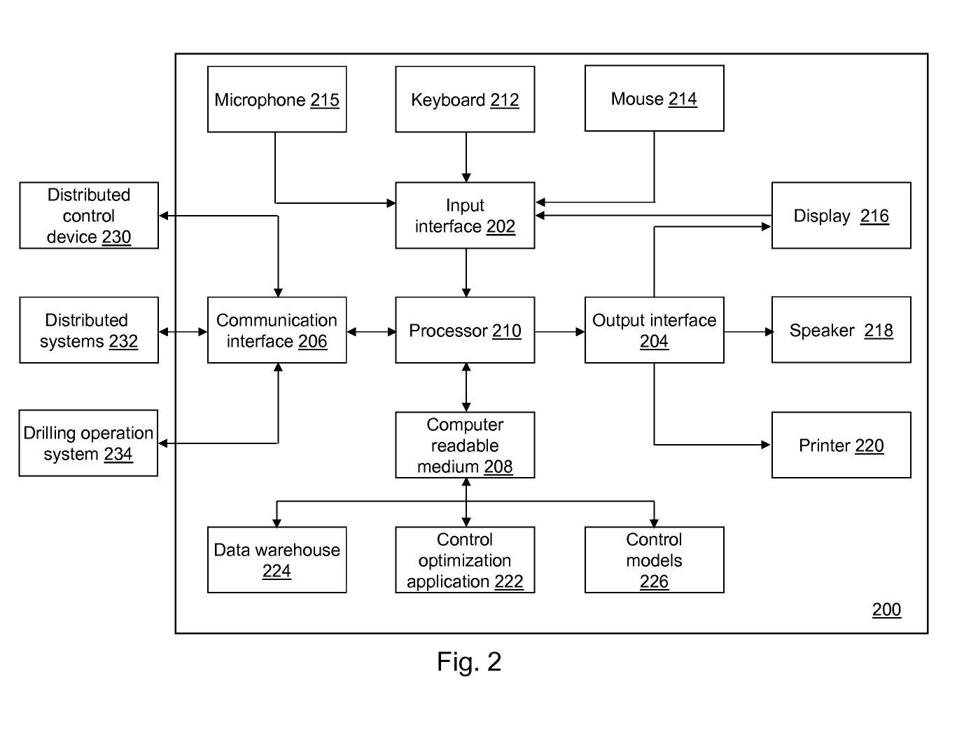

Referring to FIG. 2, a block diagram of a data optimization device 200 is shown in accordance with an illustrative embodiment. Data optimization device 200 may include an input interface 202, an output interface 204, a communication interface 206, a computer-readable medium 208, a processor 210, a control optimization application 222, a data warehouse 224, and control models 226. Fewer, different, and/or additional components may be incorporated into data optimization device 200.

Input interface 202 provides an interface for receiving information from the user for entry into data optimization device 200 as understood by those skilled in the art. Input interface 202 may interface with various input technologies including, but not limited to, a keyboard 212, a mouse 214, a microphone 215, a display 216, a track ball, a keypad, one or more buttons, etc. to allow the user to enter information into data optimization device 200 or to make selections presented in a user interface displayed on the display. The same interface may support both input interface 202 and output interface 204. For example, display 216 comprising a touch screen provides user input and presents output to the user. Data optimization device 200 may have one or more input interfaces that use the same or a different input interface technology. The input interface technology further may be accessible by data optimization device 200 through communication interface 206.

Output interface 204 provides an interface for outputting information for review by a user of data optimization device 200 and/or for use by another application. For example, output interface 204 may interface with various output technologies including, but not limited to, display 216, a speaker 218, a printer 220, etc. Data optimization device 200 may have one or more output interfaces that use the same or a different output interface technology. The output interface technology further may be accessible by data optimization device 200 through communication interface 206.

Communication interface 206 provides an interface for receiving and transmitting data between devices using various protocols, transmission technologies, and media as understood by those skilled in the art. Communication interface 206 may support communication using various transmission media that may be wired and/or wireless. Data optimization device 200 may have one or more communication interfaces that use the same or a different communication interface technology. For example, data optimization device 200 may support communication using an Ethernet port, a Bluetooth antenna, a telephone jack, a USB port, etc. Data and messages may be transferred between data optimization device 200 and/or a distributed control device 230, distributed systems 232, and/or a production operation system 234 using communication interface 206.

Computer-readable medium 208 is an electronic holding place or storage for information so the information can be accessed by processor 210 as understood by those skilled in the art. Computer-readable medium 208 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., compact disc (CD), digital versatile disc (DVD), . . . ), smart cards, flash memory devices, etc. Data optimization device 200 may have one or more computer-readable media that use the same or a different memory media technology. For example, computer-readable medium 208 may include different types of computer-readable media that may be organized hierarchically to provide efficient access to the data stored therein as understood by a person of skill in the art. As an example, a cache may be implemented in a smaller, faster memory that stores copies of data from the most frequently/recently accessed main memory locations to reduce an access latency. Data optimization device 200 also may have one or more drives that support the loading of a memory media such as a CD, DVD, an external hard drive, etc. One or more external hard drives further may be connected to data optimization device 200 using communication interface 206.

Processor 210 executes instructions as understood by those skilled in the art. The instructions may be carried out by a special purpose computer, logic circuits, or hardware circuits. Processor 210 may be implemented in hardware and/or firmware. Processor 210 executes an instruction, meaning it performs/controls the operations called for by that instruction. The term “execution” is the process of running an application or the carrying out of the operation called for by an instruction. The instructions may be written using one or more programming language, scripting language, assembly language, etc. Processor 210 operably couples with input interface 202, with output interface 204, with communication interface 206, and with computer-readable medium 208 to receive, to send, and to process information. Processor 210 may retrieve a set of instructions from a permanent memory device and copy the instructions in an executable form to a temporary memory device that is generally some form of RAM. Data optimization device 200 may include a plurality of processors that use the same or a different processing technology.

Control optimization application 222 performs operations associated with determining an optimization function from data stored in data warehouse 224. Some or all of the operations described herein may be embodied in control optimization application 222. The operations may be implemented using hardware, firmware, software, or any combination of these methods. Referring to the example embodiment of FIG. 2, control optimization application 222 is implemented in software (comprised of computer-readable and/or computer-executable instructions) stored in computer-readable medium 208 and accessible by processor 210 for execution of the instructions that embody the operations of control optimization application 222. Control optimization application 222 may be written using one or more programming languages, assembly languages, scripting languages, etc.

Control optimization application 222 may be implemented as a Web application. For example, control optimization application 222 may be configured to receive hypertext transport protocol (HTTP) responses and to send HTTP requests. The HTTP responses may include web pages such as hypertext markup language (HTML) documents and linked objects generated in response to the HTTP requests. Each web page may be identified by a uniform resource locator (URL) that includes the location or address of the computing device that contains the resource to be accessed in addition to the location of the resource on that computing device. The type of file or resource depends on the Internet application protocol such as the file transfer protocol, HTTP, H.323, etc. The file accessed may be a simple text file, an image file, an audio file, a video file, an executable, a common gateway interface application, a Java applet, an extensible markup language (XML) file, or any other type of file supported by HTTP.

Data warehouse 224 stores drilling data that includes a plurality of values measured for each of a plurality of drilling parameters during a production operation such as a SAGD production operation. The plurality of values may be measured for each of the plurality of drilling parameters at a plurality of time points during a time period. The time period may be greater than one-month. For example, the plurality of values may be measured for each of the plurality of drilling parameters hourly for a year long time period though other time period lengths and measurement intervals may be used.

The plurality of values may be measured from the same production operation, a neighboring production operation, a production operation with similar geological characteristics, etc. For example, a production operation in an environment with a similar permeability and porosity may be used. The plurality of values result from control parameter values chosen by an operator.

The data stored in data warehouse 224 may include any type of content represented in any computer-readable format such as binary, alphanumeric, numeric, string, markup language, etc. The content may include textual information, graphical information, image information, audio information, numeric information, etc. that further may be encoded using various encoding techniques as understood by a person of skill in the art. Data warehouse 224 may be stored in computer-readable medium 208 or on one or more other computing devices (e.g., distributed control device 230 and/or distributed systems 232) and accessed using communication interface 206. Data warehouse 224 may be stored using various formats as known to those skilled in the art including a file system, a relational database, a system of tables, a structured query language database, etc. For example, data warehouse 224 may be stored in a cube distributed across a grid of computers as understood by a person of skill in the art. As another example, data warehouse 224 may be stored in a multi-node Hadoop® cluster, as understood by a person of skill in the art.

Some systems may use Hadoop®, an open-source framework for storing and analyzing big data in a distributed computing environment. Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction. Some grid systems may be implemented as a multi-node Hadoop® cluster, as understood by a person of skill in the art. Apache™ Hadoop® is an open-source software framework for distributed computing. Some systems may use the SAS® LASR™ Analytic Server developed and provided by SAS Institute Inc. of Cary, N.C., USA in order to deliver statistical modeling and machine learning capabilities in a highly interactive programming environment, which may enable multiple users to concurrently manage data, convert variables, perform exploratory analysis, build and compare models and score. Some systems may use SAS In-Memory Statistics for Hadoop® developed and provided by SAS Institute Inc. of Cary, N.C., USA to read big data once and analyze it several times by persisting it in-memory for the entire session. Some systems may be of other types, designs and configurations.

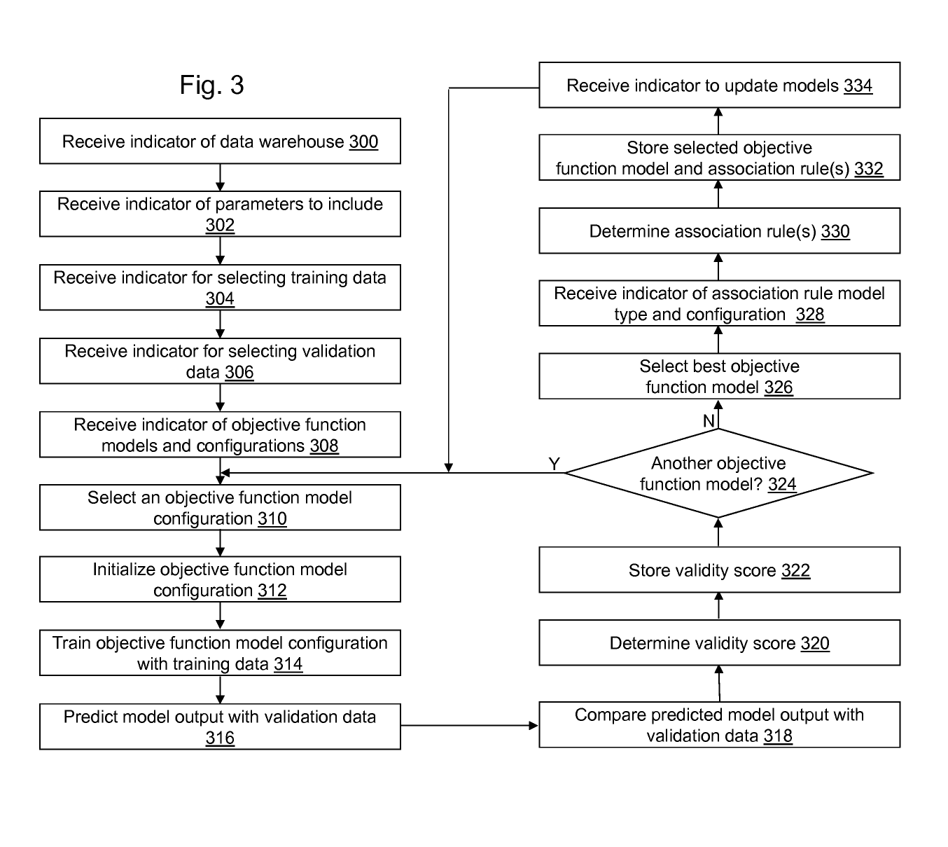

Referring to FIG. 3, example operations associated with control optimization application 222 are described. Control optimization application 222 may be used to create control models 226 using the data stored in data warehouse 224. Control models 226 support a determination of an optimal value for a control parameter of the production operation using sensed data measured during the production operation. Additional, fewer, or different operations may be performed depending on the embodiment. The order of presentation of the operations of FIG. 3 is not intended to be limiting. Although some of the operational flows are presented in sequence, the various operations may be performed in various repetitions, concurrently (in parallel, for example, using threads), and/or in other orders than those that are illustrated. For example, a user may execute control optimization application 222, which causes presentation of a first user interface window, which may include a plurality of menus and selectors such as drop down menus, buttons, text boxes, hyperlinks, etc. associated with control optimization application 222 as understood by a person of skill in the art. An indicator may indicate one or more user selections from a user interface, one or more data entries into a data field of the user interface, one or more data items read from computer-readable medium 208 or otherwise defined with one or more default values, etc. that are received as an input by control optimization application 222.

In an operation 300, a first indicator of data warehouse 224 is received. For example, the first indicator indicates a location of data warehouse 224. As an example, the first indicator may be received by control optimization application 222 after selection from a user interface window or after entry by a user into a user interface window. In an alternative embodiment, data warehouse 224 may not be selectable. For example, a most recently created data warehouse may be used automatically.

As discussed previously, data warehouse 224 may be stored in a cube distributed across a grid of computers, may be stored in a multi-node Hadoop® cluster distributed across one or more computers, may be stored in a file system distributed across one or more computers, in a relational database, in one or more tables, in a structured query language database, etc.

In an operation 302, a second indicator of parameters to include in determining control models 226 is received. The parameters are production operation parameters measured by sensors of various types during the production operation. Example parameters include a pump speed, a header pressure, an injection in a short string, an injection in a long string, a casing gas, a sub-cool temperature value, a material extracted, a porosity, a permeability, an azimuth or angular measurements, a produced emulsion (that contains oil and water or other combinations of fluid), etc. A sub-cool temperature value is a difference between a boiling point of water and a temperature of a material produced by the production operation at a same pressure. For example, the sub-cool temperature value may be measured at a heel of producer well 108 as understood by a person of skill in the art. Example sensors include pressure sensors, temperature sensors, position sensors, velocity sensors, acceleration sensors, flow rate sensors, etc. that may be mounted to various components used as part of the production operation. Production operation systems 234 include the sensors mounted to various components used as part of the production operation as well as the various components themselves.

The second indicator may indicate that only a portion of the parameters stored in data warehouse 224 be included when defining control models 226. In an alternative embodiment, the second indicator may not be received. For example, all or a subset of the parameters may be used automatically.

In an operation 304, a third indicator for selecting training data from data warehouse 224 is received. The third indicator may be received by control optimization application 222, for example, after selection from a user interface window or after entry by a user into a user interface window. The third indicator identifies a first portion of the data stored in data warehouse 224 to use in training a model. The third indicator may indicate a number of data points to include, a percentage of data points of the entire data warehouse 224 to include, etc. A subset may be created from data warehouse 224 by sampling. An example sampling algorithm is uniform sampling. Other random sampling algorithms may be used.

In an operation 306, a fourth indicator for selecting validation data from data warehouse 224 is received. The fourth indicator may be received by control optimization application 222, for example, after selection from a user interface window or after entry by a user into a user interface window. The fourth indicator identifies a second portion of the data stored in data warehouse 224 to use in validating the model. The fourth indicator may indicate a number of data points to include, a percentage of data points of the entire data warehouse 224 to include, etc. A subset may be created from data warehouse 224 by sampling. An example sampling algorithm is uniform sampling. Other random sampling algorithms may be used. The data points from data warehouse 224 selected for the validation data may be distinct from the data points from data warehouse 224 selected for the training data.

In an operation 308, a fifth indicator of one or more types of objective function models and configurations is received. For example, the fifth indicator indicates a name of a type of objective function model. For illustration, the name may be “Neural Network”, “Linear Regression”, “Non-linear Regression”, Support Vector Machine”, etc. A configuration identifies one or more initialization values based on the type of objective function model. For example, when the type of objective function model is indicated as “Neural Network”, a number of hidden layers, a number of nodes per layer, a propagation method, etc. may be identified by the fifth indicator. A plurality of configurations may be defined. For example, when the type of objective function model is neural network, a range of numbers of hidden layers, a range of numbers of nodes per layer, etc. also may be identified by the fifth indicator.

The fifth indicator may be received by control optimization application 222 after selection from a user interface window or after entry by a user into a user interface window. A default value for the types of objective function models and configurations may further be stored, for example, in computer-readable medium 208. In an alternative embodiment, the types of objective function models and configurations may not be selectable.

In an operation 310, an objective function model is selected based on the fifth indicator or based on a default model stored in computer-readable medium 208. In an operation 312, the selected objective function model is initialized. In an operation 314, the initialized objective function model is trained using the training data as indicated by the second indicator and the third indicator.

In an operation 316, output data is predicted with the validation data, as indicated by the second indicator and the fourth indicator, as an input to the trained objective function model. In an operation 318, the predicted output data is compared to the actual output data included in the validation data. In an operation 320, a validity score is determined based on the comparison. In an operation 322, the determined validity score is stored, for example, in computer-readable medium 208 in association with an indicator of the selected objective function model. As an example, SAS® Enterprise Miner™ developed and provided by SAS Institute Inc. of Cary, N.C., USA includes a neural network procedure PROCNEURAL that can be used to configure, initialize, train, predict, and score a neural network model. The input nodes are the control variables and the output node(s) is oil production, water usage, or sub-cool temperature value, or all three. For illustration, the objective function model may be implemented as a neural network with two or three hidden nodes, a feed-forward adaptation, a supervised learning mode, and back-propagation to perform sensitivity analysis that determines how each input parameter (e.g., the pump speed, header pressure, the short injection string, the long injection string, the casing gas, the produced emulsion) influences the output node(s) (e.g., water usage, oil production, sub-cool temperature value).

In an operation 324, a determination is made concerning whether or not there is another objective function model to evaluate. When there is another objective function model to evaluate, processing continues in operation 310. When there is not another objective function model to evaluate, processing continues in an operation 326. In operation 310, a next objective function model is selected based on the fifth indicator.

In operation 326, a best objective function model is selected. For example, the validity scores stored for each iteration of operation 322 are compared and the objective function model associated with the best validity score is selected. The best validity score may be a minimum or a maximum value of the validity scores stored for each iteration of operation 322. For example, if the validity score is a misclassification rate, a minimum validity score indicates the best model; whereas, if the validity score is a correct classification rate, a maximum validity score indicates the best model.

In an operation 328, a sixth indicator of an association rule model type and configuration is received. For example, the sixth indicator indicates a name of the association rule model type. For illustration, the name may be “Decision Tree”, “Associate”, etc. As an example, SAS® Enterprise Miner™ includes a procedure PROCASSOC that can be used as an association rule model type. A configuration identifies one or more initialization values based on the association rule model type. For example, when the association rule model type is decision tree, a stop criterion may be identified by the sixth indicator. As an example, SAS® Enterprise Miner™ includes a decision tree procedure that can be used to build one or more decision tree models.

In an operation 330, an association rule or rules are determined using the data in the data warehouse indicated in operation 302. The association rule defines a range of values for a control parameter (“Then” in Table I below) of a plurality of production parameters that is selected based on a value of a first parameter (“When” in Table I below) of the plurality of production parameters. As an example, SAS® Enterprise Miner™ includes a procedure HPFOREST that can be used to determine an association rule(s). For example, Table I below identifies a plurality of associations rules:

TABLE I

| Association | | | Confi- |
|---|---|---|---|
| Rule # | When | Then | dence |
| 1 | Oil production volume is | Steam to long tubing flow | 93% |
| | between 6.6 and 6.9 | rate is between -∞ and | |
| | meters (m)³/hour (h) | 191.8 kilopascal (kPa) | |
| 2 | Oil production volume is | Steam to long tubing flow | 80% |
| | between 5.4 and 5.8 m³/h | rate is between 1342 and | |
| | | 1534 kPa | |
| 3 | Oil production volume is | Steam to long tubing flow | 76% |
| | between 2.7 and 3.1 m³/h | rate is between 3644 and | |
| | | 3835 kPa | |
| 4 | Oil production volume is | Sub-cool temperature is | 67% |
| | between 6.4 and 6.9 m³/h | between 24.1 and 25.1° C. | |
| 5 | Sub-cool temperature is | Oil production volume is | 54% |
| | between 18.4 and 19.4° C. | between 3.4 and 4.1 m³/h | |

As another example, Table II below identifies a plurality of associations rules:

TABLE II

| Association | | | Confi- |
|---|---|---|---|
| Rule # | When | Then | dence |
| 1 | Oil production volume is | Steam to long tubing flow | 87% |
| | between 8.9 and 9.9 m³/h | rate is between 4076 and | |
| | | 4524 kPa | |
| 2 | Steam to long tubing flow | Oil production volume is | 75% |
| | rate is between 4524 and | between 4.9 and 5.9 m³/h | |
| | 4972 kPa | | |
| 3 | Steam to long tubing flow | Oil production volume is | 60% |
| | rate is between 3627 and | between 3.9 and 4.9 m³/h | |
| | 4076 kPa | | |
| 4 | Sub-cool temperature is | Oil production volume is | 88% |
| | between 25.8 and 28.5° C. | between 2.9 and 3.9 m³/h | |
| 5 | Sub-cool temperature is | Oil production volume is | 65% |
| | between 20.6 and 23.2° C. | between 8.9 and 9.9 m³/h | |

A confidence value may be determined for each association rule and only those rules having a confidence value above a predetermined threshold may be determined as strong association rules or association rules that show a consistent pattern in the data. For illustration, the confidence value may be determined as a ratio of the number of occurrences of the “When” to the number of occurrences of the “Then” in the data.

In an operation 332, the selected objective function model and the association rule(s) are stored, for example, in computer-readable medium 208. The selected objective function model and the association rule(s) may be stored in association with a specific drilling location, a specific drilling field, a specific type of drilling environment, etc. The selected objective function model and the association rule(s) are control models 226. The association rule(s) may be stored as constraints.

As an example, the best objective function model may have the form Oilₘₐₓ=k₁Wₚ−k₂W_{c}+k₃Pₛ−k₄Sₛ−k₅Sₗ subject to T₁<Wₚ≦T₂; T₃<W_{c}≦T₄; T₅<Pₛ≦T₆; T₇<Sₛ≦T₈; T₉<Sₗ≦T₁₀, where Wₚ is a well production to header pressure, W_{c} is a well casing gas to header pressure, Pₛ is a pump speed reference in hertz, Sₛ is a steam to short tubing, Sₗ is a steam to long tubing, k₁, k₂, k₃, k₄, k₅ are determined from the training of the objective function model, and T₁, T₂, T₃, T₄, T₅, T₆, T₇, T₈, T₉, T₁₀ are association rule constraint values.

In an operation 334, a seventh indicator is received to update the selected objective function model and the association rule(s). For example, the selected objective function model and the association rule(s) may be updated periodically such as every day, every week, every month, every year, etc. A timer may trigger receipt of the seventh indicator. A user may trigger receipt of the seventh indicator. For example, a user may monitor production parameters and determine that an update of the selected objective function model and the association rule(s) be performed. When the seventh indicator is received, processing continues in operation 310. Processing may continue in operation 310 using the data used in a previous iteration of operation 332 in addition to data measured and stored subsequent to the last iteration of operation 332. As another option, processing may continue in operation 310 using the data measured and stored subsequent to the last iteration of operation 332. Data from the same or a different production operation may be used. In an alternative embodiment, the seventh indicator may not be received and processing is complete.

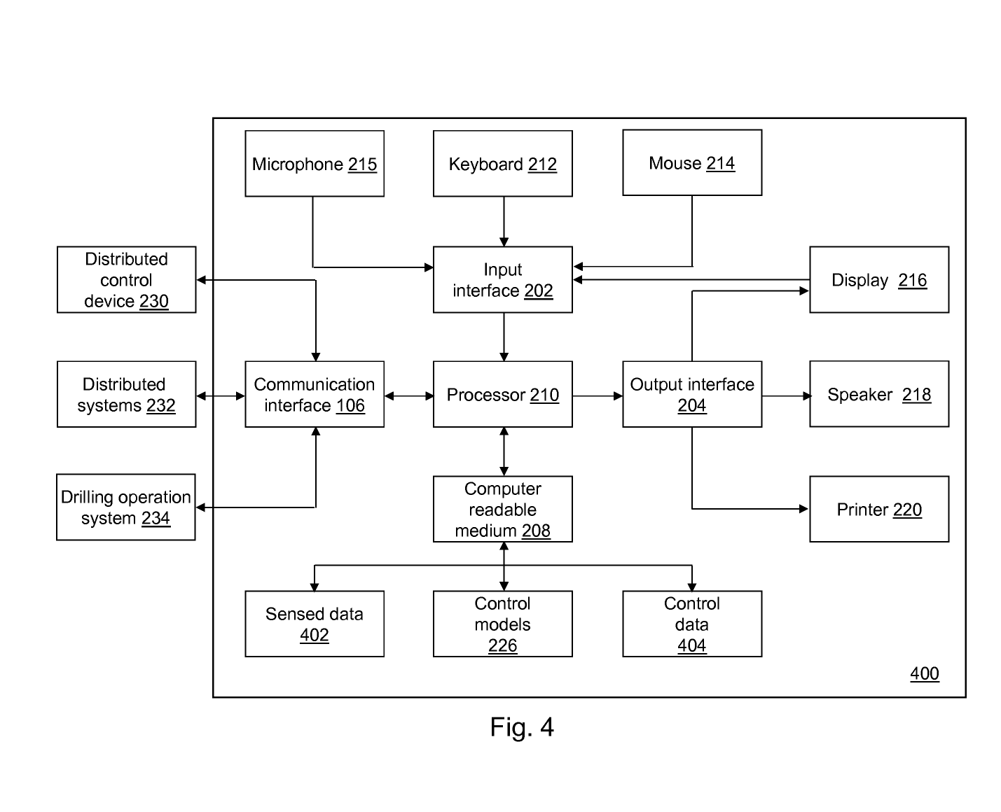

Referring to FIG. 4, data optimization device 200 further may include sensed data 402 and control data 404. Control models 226 support a determination of an optimal value for a control parameter (control data 404) of the production operation using sensed data 402 measured during the production operation. Some or all of the operations described herein may be embodied in control models 226. Control optimization application 222 and control models 226 may be integrated into a single application, may be separate applications, or control optimization application 222 and control models 226 may be integrated at other levels than those illustrated.

The operations of control models 226 may be implemented using hardware, firmware, software, or any combination of these methods. Referring to the example embodiment of FIG. 4, control models 226 are implemented in software (comprised of computer-readable and/or computer-executable instructions) stored in computer-readable medium 208 and accessible by processor 210 for execution of the instructions that embody the operations of control models 226. Control models 226 may be written using one or more programming languages, assembly languages, scripting languages, etc. Control models 226 may be implemented as a Web application.

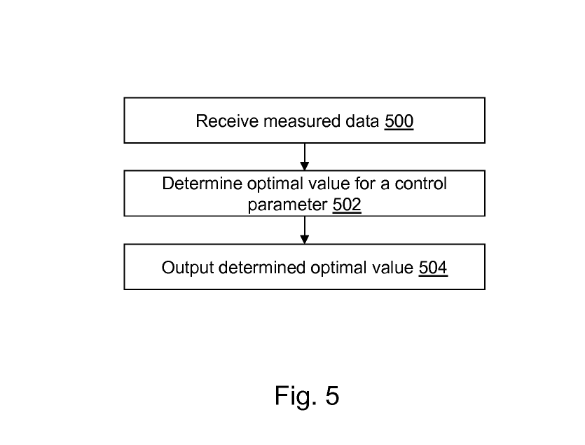

Referring to FIG. 5, example operations associated with control models 226 are described. Additional, fewer, or different operations may be performed depending on the embodiment. The order of presentation of the operations of FIG. 5 is not intended to be limiting. Although some of the operational flows are presented in sequence, the various operations may be performed in various repetitions, concurrently (in parallel, for example, using threads), and/or in other orders than those that are illustrated.

In an operation 500, measured data 402 is received. For example, sensed data associated with the parameters indicated in operation 302 are received in near real-time from the sensors measuring the current control parameter values of the production operation.

In an operation 502, an optimal value for a control parameter of the production operation is determined by executing the selected objective function model with the received, measured drilling data as an input and subject to the determined association rule(s). The selected objective function maximizes production of the material produced by the production operation, minimizes water usage by the production operation, and minimizes the sub-cool temperature value. As an example, SAS®OR developed and provided by SAS Institute Inc. of Cary, N.C., USA includes an OPTMODEL procedure that provides a framework for specifying and solving a nonlinear optimization problem using range constraints as defined by the association rule(s). Example control parameter include a pump speed, a header pressure, a short injection string, a long injection string, a casing gas, a produced emulsion, etc.

In an operation 504, the determined optimal value for the control parameter of the production operation is output. For example, the determined optimal value is output to display 216, speaker 218, and/or printer 220 for review by a user. As another example, the determined optimal value is output to a prediction model to predict the effect of the determined optimal value on the production operation. As yet another example, the determined optimal value is output to a control device associated with adjusting a set point of the control parameter.

When the determined optimal value for the control parameter of the production operation is greater than a current value of the control parameter, the value of the control parameter may be reduced; whereas, when the determined optimal value for the control parameter of the production operation is less than a current value of the control parameter, the value of the control parameter may be increased.

Predicting the effect of the determined optimal value on the production operation provides a method for determining whether or not a global or a local optimality for the control parameter of the production operation is determined. For example, increasing/decreasing the control parameter greater/less than the determined optimal value and predicting the effect provides a method to test the sensitivity to changes in the control parameter and to evaluate if the optimal value is a global or a local value.

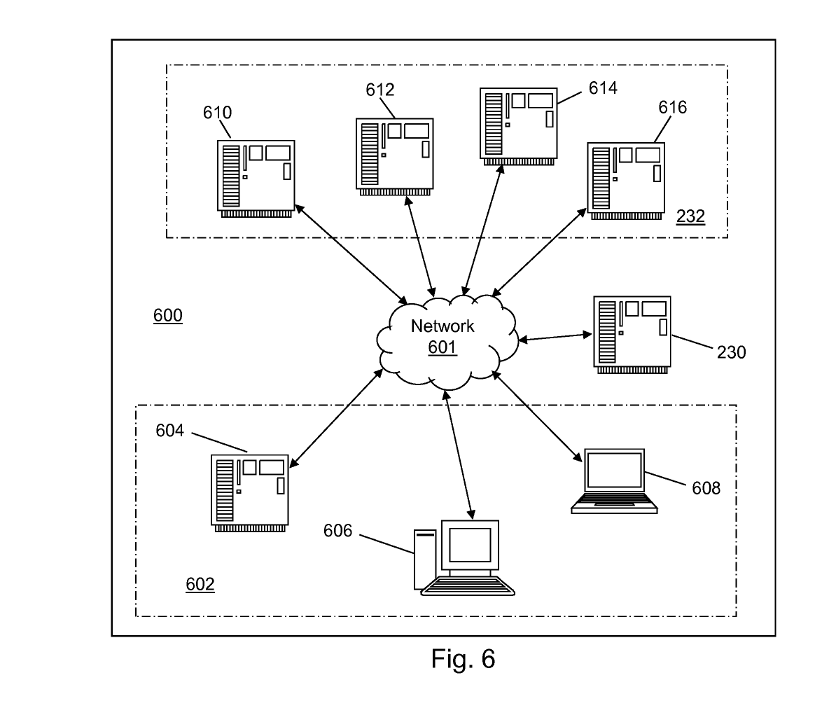

If data optimization device 200 is multi-threaded, one or more of the operations of FIGS. 3 and 5 may be performed in parallel. If data warehouse 224 and/or control models 226 are distributed across one or more other devices, a distributed processing system can be used. For example, referring to FIG. 6, a block diagram of a distributed processing system 600 is shown in accordance with an illustrative embodiment. In an illustrative embodiment, distributed processing system 600 may include distributed control device 230, distributed systems 232, data optimization systems 602, and a network 601. For illustration, distributed control device 230 and distributed systems 232 may be implemented as a multi-node Hadoop® cluster, as understood by a person of skill in the art. As another illustration, distributed systems 232 may store a cube of data. Data optimization systems 602 access data stored in the cube of data or in the Hadoop® cluster distributed to the distributed systems 232. Distributed control device 230 coordinates and controls access by data optimization systems 602 to the data stored by the distributed systems 232. One or more components of distributed processing system 600 may support multithreading, as understood by a person of skill in the art.

The components of distributed processing system 600 may be located in a single room or adjacent rooms, in a single facility, and/or may be distributed geographically from one another. Each of distributed systems 232, data optimization systems 602, and distributed control device 230 may be composed of one or more discrete devices.

Network 601 may include one or more networks of the same or different types. Network 601 can be any type of wired and/or wireless public or private network including a cellular network, a local area network, a wide area network such as the Internet, etc. Network 601 further may comprise sub-networks and consist of any number of devices.

Data optimization systems 602 can include any number and type of computing devices that may be organized into subnets. Data optimization device 200 is an example computing device of data optimization systems 602. The computing devices of data optimization systems 602 send and receive communications through network 601 to/from another of the one or more computing devices of data optimization systems 602, to/from distributed systems 232, and/or to/from distributed control device 230. The one or more computing devices of data optimization systems 602 may include computers of any form factor such as a server 604, a desktop 606, a laptop 608, a personal digital assistant, an integrated messaging device, a tablet computer, etc. The one or more computing devices of data optimization systems 602 may communicate using various transmission media that may be wired and/or wireless as understood by those skilled in the art.

For illustration, FIG. 6 represents distributed systems 232 with a first server computer 610, a second server computer 612, a third server computer 614, and a fourth server computer 616. Distributed systems 232 can include any number and form factor of computing devices that may be organized into subnets. The computing devices of distributed systems 232 send and receive communications through network 601 to/from another of the one or more computing devices of distributed systems 232, to/from distributed control device 230, and/or to/from data optimization systems 602. The one or more computing devices of distributed systems 232 may communicate using various transmission media that may be wired and/or wireless as understood by those skilled in the art.

In the illustrative embodiment, distributed control device 230 is represented as a server computing device though distributed control device 230 may include one or more computing devices of any form factor that may be organized into subnets. Distributed control device 230 sends and receives communications through network 601 to/from distributed systems 232 and/or to/from data optimization systems 602. Distributed control device 230 may communicate using various transmission media that may be wired and/or wireless as understood by those skilled in the art.

Distributed processing system 600 may use cloud computing technologies, which support on-demand network access to a shared pool of configurable computing resources (e.g., networks, servers, storage, applications and services) that can be rapidly provisioned and released with minimal management effort or service provider interaction. Distributed processing system 600 may use the SAS® LASR™ Analytic Server to deliver statistical modeling and machine learning capabilities in a highly interactive programming environment, which may enable multiple users to concurrently manage data, transform variables, perform exploratory analysis, and build and compare models. Distributed processing system 600 may use SAS In-Memory Statistics for Hadoop® to read big data once and analyze it several times by persisting it in-memory. Some systems may be of other types and configurations.

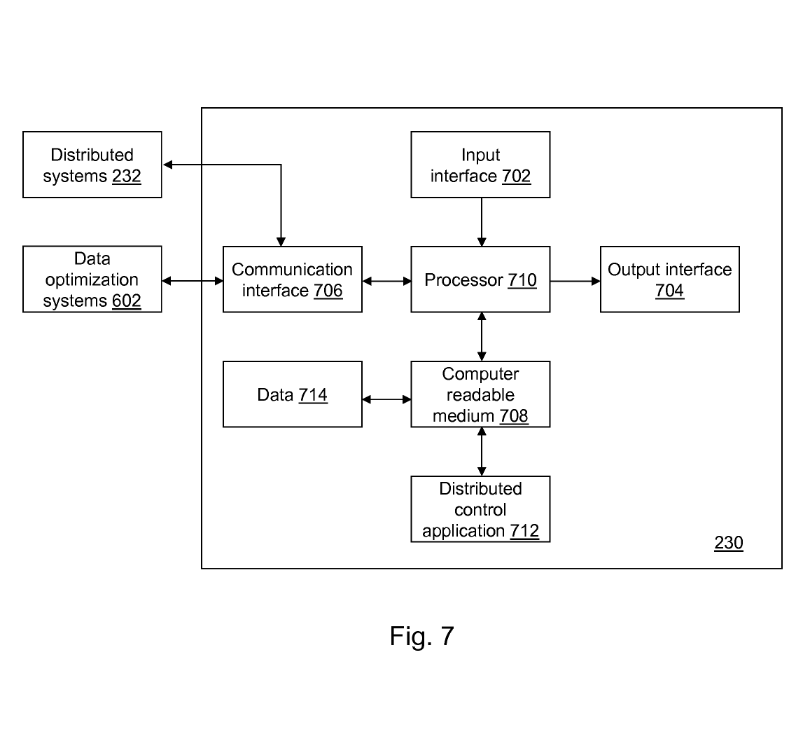

Referring to FIG. 7, a block diagram of distributed control device 230 is shown in accordance with an example embodiment. Distributed control device 230 may include a second input interface 702, a second output interface 704, a second communication interface 706, a second computer-readable medium 708, a second processor 710, a distributed control application 712, and second data 714. Fewer, different, and additional components may be incorporated into distributed control device 230.

Second input interface 702 provides the same or similar functionality as that described with reference to input interface 102 of data optimization device 200 though referring to distributed control device 230. Second output interface 704 provides the same or similar functionality as that described with reference to output interface 204 of data optimization device 200 though referring to distributed control device 230. Second communication interface 706 provides the same or similar functionality as that described with reference to communication interface 106 of data optimization device 200 though referring to distributed control device 230. Data and messages may be transferred between distributed control device 230 and distributed systems 232 and/or data optimization systems 602 using second communication interface 706. Second computer-readable medium 708 provides the same or similar functionality as that described with reference to computer-readable medium 108 of data optimization device 200 though referring to distributed control device 230. Second processor 710 provides the same or similar functionality as that described with reference to processor 110 of data optimization device 200 though referring to distributed control device 230.

Distributed control application 712 performs operations associated with controlling access to the distributed data, with performing one or more operations described with reference to FIGS. 3 and 5, and/or with instructing distributed systems 232 to perform one or more operations described with reference to FIGS. 3 and 5.

Some or all of the operations described herein may be embodied in distributed control application 712. The operations may be implemented using hardware, firmware, software, or any combination of these methods. Referring to the example embodiment of FIG. 7, distributed control application 712 is implemented in software (comprised of computer-readable and/or computer-executable instructions) stored in second computer-readable medium 708 and accessible by second processor 710 for execution of the instructions that embody the operations of distributed control application 712. Distributed control application 712 may be written using one or more programming languages, assembly languages, scripting languages, etc. Distributed control application 712 may be implemented as a Web application.

Second data 714 may include data used by distributed control application 712 in support of creating control models 226 and/or in determining an optimal value for a control parameter of the production operation using measured data sensed during the production operation.

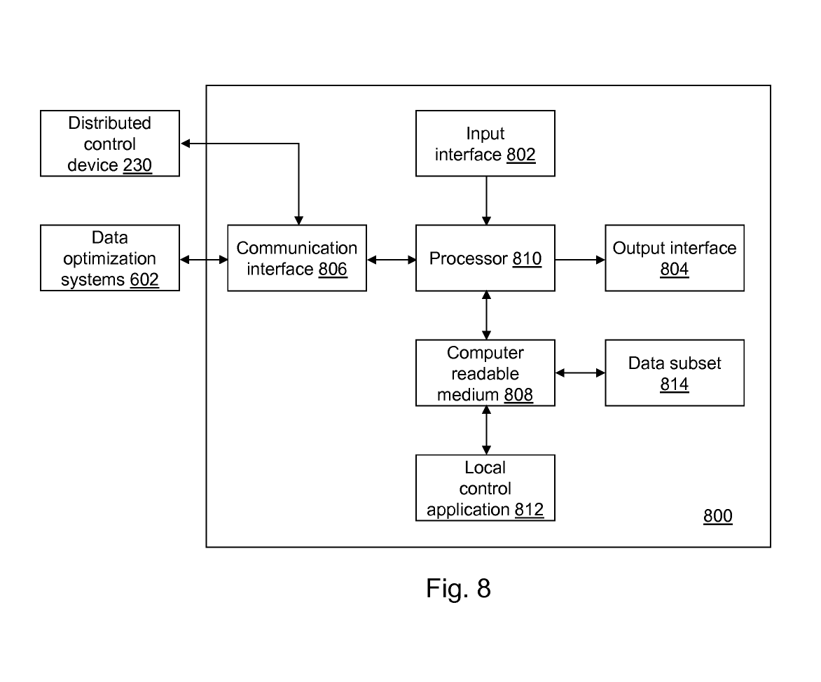

Referring to FIG. 8, a block diagram of a data node device 800 is shown in accordance with an illustrative embodiment. Data node device 800 is an example computing device of distributed systems 232. Data node device 800 may include a third input interface 802, a third output interface 804, a third communication interface 806, a third computer-readable medium 808, a third processor 810, a local control application 812, and a data subset 814. Fewer, different, and additional components may be incorporated into data node device 800.

Third input interface 802 provides the same or similar functionality as that described with reference to input interface 102 of data optimization device 200 though referring to data node device 800. Third output interface 804 provides the same or similar functionality as that described with reference to output interface 104 of data optimization device 200 though referring to data node device 800. Third communication interface 806 provides the same or similar functionality as that described with reference to communication interface 206 of data optimization device 200 though referring to data node device 800. Data and messages may be transferred between data node device 800 and distributed control device 230 and/or data optimization systems 602 using third communication interface 806. Third computer-readable medium 808 provides the same or similar functionality as that described with reference to computer-readable medium 208 of data optimization device 200 though referring to data node device 800. Third processor 810 provides the same or similar functionality as that described with reference to processor 210 of data optimization device 200 though referring to data node device 800.

Local control application 812 performs operations associated with controlling access to the data stored in data subset 2014 and/or with executing one or more operations described with reference to FIGS. 3 and 5. Some or all of the operations described herein may be embodied in local control application 812. The operations may be implemented using hardware, firmware, software, or any combination of these methods. Referring to the example embodiment of FIG. 8, local control application 812 is implemented in software (comprised of computer-readable and/or computer-executable instructions) stored in third computer-readable medium 808 and accessible by third processor 810 for execution of the instructions that embody the operations of local control application 812. Local control application 812 may be written using one or more programming languages, assembly languages, scripting languages, etc. Local control application 812 may be implemented as a Web application.

Data subset 814 stores a portion of data warehouse 224 distributed across distributed systems 232 with each computing device of the distributed systems 232 storing a different portion of data warehouse 224. Distributed control device 230 further may store a portion of data warehouse 224.

A user may execute data optimization application 222 that interacts with distributed control application 712 by requesting that distributed control device 230 perform one or more operations described with reference to FIGS. 3 and 5. Distributed control application 712 triggers processing by local control application 812 executing at each node device of the distributed systems 232 to perform one or more operations described with reference to FIGS. 3 and 5. Any number of different users may be accessing the data at any given time.

Various levels of integration between the components of distributed processing system 600 may be implemented without limitation as understood by a person of skill in the art. For example, local control application 812 and distributed control application 712 may be the same or different applications or part of an integrated, distributed application supporting some or all of the same or additional types of functionality as described herein. As another example, data optimization application 222 and distributed control application 712 may be the same or different applications or part of an integrated, distributed application supporting some or all of the same or additional types of functionality as described herein.

The various operations described with reference to FIGS. 3 and 5 provide a process for automatically generating optimal control parameter values for use by a production operation operator or by a control device to control operational settings for various drilling components. The optimal control parameter values may result in an increase in material production, while minimizing water and subcool temperatures simultaneously.

Using similarity measures to systematically choose a best neural network model can be an effective way to reduce time in a model building stage. Automation of what-if analysis can also be an effective way to determine if the results from the optimization routines provide global or local optima.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, using “and” or “or” in the detailed description is intended to include “and/or” unless specifically indicated otherwise. The illustrative embodiments may be implemented as a method, apparatus, or article of manufacture using standard programming and/or engineering techniques to produce software, firmware, hardware, or any combination thereof to control a computer to implement the disclosed embodiments.

The foregoing description of illustrative embodiments of the disclosed subject matter has been presented for purposes of illustration and of description. It is not intended to be exhaustive or to limit the disclosed subject matter to the precise form disclosed, and modifications and variations are possible in light of the above teachings or may be acquired from practice of the disclosed subject matter. The embodiments were chosen and described in order to explain the principles of the disclosed subject matter and as practical applications of the disclosed subject matter to enable one skilled in the art to utilize the disclosed subject matter in various embodiments and with various modifications as suited to the particular use contemplated.

What is claimed is:

1. A non-transitory computer-readable medium having stored thereon computer-readable instructions that when executed by a computing device cause the computing device to:
receive drilling data, wherein the drilling data includes a plurality of values measured for each of a plurality of drilling parameters;
determine an objective function using the received drilling data, wherein the objective function maximizes production of a material produced by a production operation, minimizes water usage by the production operation, and minimizes a difference between a boiling point of water and a temperature of the material produced by the production operation at a same pressure;
determine an association rule using the received drilling data, wherein the association rule defines a range of values for a control parameter of the plurality of drilling parameters that is selected based on a value of a first parameter of the plurality of drilling parameters;
receive measured drilling data that indicates current control parameter values of the production operation;
determine an optimal value for the control parameter of the production operation by executing the determined objective function with the received, measured drilling data as an input and subject to the determined association rule; and
output the determined optimal value for the control parameter of the production operation.

2. The non-transitory computer-readable medium of claim 1, wherein the objective function is determined using a neural network model.

3. The non-transitory computer-readable medium of claim 1, wherein the objective function is determined by evaluating a plurality of neural network model configurations.

4. The non-transitory computer-readable medium of claim 1, wherein determining the objective function comprises:
defining a training dataset as a first portion of the received drilling data;
defining a validation dataset as a second portion of the received drilling data;
defining a first neural network model configuration;
training a first neural network model using the defined training dataset based on the defined first neural network model configuration;
predicting model output data with the defined validation dataset as an input to the trained first neural network model;
comparing the predicted model output data to output data of the validation dataset; and
determining a first validity score for the trained first neural network model based on comparing the predicted model output data to output data of the validation dataset.

5. The non-transitory computer-readable medium of claim 4, wherein determining the objective function further comprises:
defining a second neural network model configuration;
training a second neural network model using the defined training dataset based on the defined second neural network model configuration;
predicting second model output data with the defined validation dataset as an input to the trained second neural network model;
comparing the predicted second model output data to the output data of the validation dataset; and
determining a second validity score for the trained second neural network model based on comparing the predicted second model output data to the output data of the validation dataset.

6. The non-transitory computer-readable medium of claim 5, wherein the objective function is determined as the trained first neural network model or the trained second neural network model based on a comparison between the determined first validity score and the determined second validity score.

7. The non-transitory computer-readable medium of claim 1, wherein a plurality of association rules are determined using the received drilling data.

8. The non-transitory computer-readable medium of claim 1, wherein the computer-readable instructions further cause the computing device to determine a second association rule using the received drilling data, wherein the second association rule defines a second range of values for the control parameter of the plurality of drilling parameters that is selected based on a second value of a second parameter of the plurality of drilling parameters.

9. The non-transitory computer-readable medium of claim 8, wherein the first parameter is the same as the second parameter.

10. The non-transitory computer-readable medium of claim 1, wherein the computer-readable instructions further cause the computing device to determine a second association rule using the received drilling data, wherein the second association rule defines a range of values for a second control parameter of the plurality of drilling parameters that is selected based on a second value of a second parameter of the plurality of drilling parameters.

11. The non-transitory computer-readable medium of claim 10, wherein the first parameter is the same as the second parameter.

12. The non-transitory computer-readable medium of claim 1, wherein the association rule is determined using a decision tree model.

13. The non-transitory computer-readable medium of claim 1, wherein the production operation is a steam assisted gravity drainage production operation.

14. The non-transitory computer-readable medium of claim 13, wherein the control parameter is selected from a pump speed, a header pressure, a short injection string, a long injection string, a casing gas, and an amount of material extracted.

15. The non-transitory computer-readable medium of claim 1, wherein the material produced by the production operation includes bitumen.

16. The non-transitory computer-readable medium of claim 1, wherein the computer-readable instructions further cause the computing device to:
receive new drilling data, wherein the new drilling data includes a second plurality of values measured for each of the plurality of drilling parameters, wherein the new drilling data is measured after outputting the determined optimal value for the control parameter of the production operation;
determine a second objective function using the received new drilling data, wherein the second objective function maximizes production of the material by the production operation, minimizes water usage by the production operation, and minimizes the difference between the boiling point of water and the temperature of the material produced by the production operation at the common pressure;
determine a second association rule using the received new drilling data, wherein the second association rule defines a second range of values for a second control parameter of the plurality of drilling parameters that is selected based on a second value of a second parameter of the plurality of drilling parameters;
receive second measured drilling data that indicates second current control parameter values of the production operation;
determine a second optimal value for the second control parameter of the production operation by executing the determined second objective function with the received, second measured drilling data as an input and subject to the determined second association rule; and
output the determined second optimal value for the second control parameter of the production operation.

17. The non-transitory computer-readable medium of claim 16, wherein the control parameter is the same as the second control parameter.

18. The non-transitory computer-readable medium of claim 16, wherein the first parameter is the same as the second parameter.

19. The non-transitory computer-readable medium of claim 16, wherein the received new drilling data includes the received drilling data.

20. The non-transitory computer-readable medium of claim 1, wherein the plurality of values are measured for each of the plurality of drilling parameters at a plurality of time points during a time period of greater than one month.

21. The non-transitory computer-readable medium of claim 1, wherein the determined optimal value is output to a display device.

22. The non-transitory computer-readable medium of claim 1, wherein the determined optimal value is output to a control device associated with adjusting a set point of the control parameter.

23. A computing device comprising:
a processor; and
a non-transitory computer-readable medium operably coupled to the processor, the computer-readable medium having computer-readable instructions stored thereon that, when executed by the processor, cause the computing device to
receive drilling data, wherein the drilling data includes a plurality of values measured for each of a plurality of drilling parameters;
determine an objective function using the received drilling data, wherein the objective function maximizes production of a material produced by a production operation, minimizes water usage by the production operation, and minimizes a difference between a boiling point of water and a temperature of the material produced by the production operation at a same pressure;
determine an association rule using the received drilling data, wherein the association rule defines a range of values for a control parameter of the plurality of drilling parameters that is selected based on a value of a first parameter of the plurality of drilling parameters;
receive measured drilling data that indicates current control parameter values of the production operation;
determine an optimal value for the control parameter of the production operation by executing the determined objective function with the received, measured drilling data as an input and subject to the determined association rule; and
output the determined optimal value for the control parameter of the production operation.

24. The computing device of claim 23, wherein the objective function is determined using a neural network model.

25. The computing device of claim 23, wherein a plurality of association rules are determined using the received drilling data.

26. The computing device of claim 23, wherein the association rule is determined using a decision tree model.

27. A method of determining an optimal value for a control parameter of a production operation, the method comprising:
receiving drilling data, wherein the drilling data includes a plurality of values measured for each of a plurality of drilling parameters;
determining, by a computing device, an objective function using the received drilling data, wherein the objective function maximizes production of a material produced by a production operation, minimizes water usage by the production operation, and minimizes a difference between a boiling point of water and a temperature of the material produced by the production operation at a same pressure;
determining, by the computing device, an association rule using the received drilling data, wherein the association rule defines a range of values for a control parameter of the plurality of drilling parameters that is selected based on a value of a first parameter of the plurality of drilling parameters;
receive measured drilling data that indicates current control parameter values of the production operation;
determining, by the computing device, an optimal value for the control parameter of the production operation by executing the determined objective function with the received, measured drilling data as an input and subject to the determined association rule; and
outputting, by the computing device, the determined optimal value for the control parameter of the production operation.

28. The method of claim 27, wherein the objective function is determined using a neural network model.

29. The method of claim 27, wherein a plurality of association rules are determined using the received drilling data.

30. The method of claim 27, wherein the association rule is determined using a decision tree model.
